(19) United States
(12) Patent Application Publication
(10) Pub. No.: US 2011/0198765 A1
(43) Pub. Date: Aug. 18, 2011

(54) OPTICAL TRANSMISSION MEDIUM SHAPING METHOD, OPTICAL TRANSMISSION MEDIUM SHAPING APPARATUS, AND OPTICAL TRANSMISSION MEDIUM MANUFACTURING METHOD

(75) Inventor: Kyoichi Sasaki, Shizuoka (JP)

(73) Assignee: TOMOEGAWA CO., LTD., Tokyo (JP)

(21) Appl. No.: 13/124,630

(22) PCT Filed: Oct. 16, 2009
(86) PCT No.: PCT/JP2009/005414

§ 371 Date: Apr. 15, 2011

(30) Foreign Application Priority Data
Oct. 17, 2008 (JP) 2008268945
Dec. 25, 2008 (JP) 2008330897

(51) Int. Cl. B29D 11/00; G02B 6/00

(52) U.S. Cl. 264/1.24; 425/392

(57) ABSTRACT

An optical transmission medium shaping method and an optical transmission medium shaping apparatus can accurately adjust desire curvature radius without cracking the optical transmission medium. The optical transmission medium shaping method for bending an optical transmission medium using a transferring means and a noncontacting heating means, includes a transferring and heating process for heating part of the optical transmission medium by the noncontacting heating means while transferring the transferring means, and a bending process for bending the optical transmission medium.

### BACKGROUND OF THE INVENTION

1. Field of the Invention

The present invention relates to an optical transmission medium shaping method, an optical transmission medium shaping apparatus, and an optical transmission medium manufacturing method.

2. Description of Related Art

As a technique for shaping an optical transmission medium, for example, techniques described in Patent Publication 1 and Non-Patent Publication 1 are well known.

Patent Publication 1 discloses a technique for deforming an optical fiber in which part of the optical fiber is heated using arc discharge and the optical fiber is bent to a desired angle so as to be in a desired bending state.

In addition, Non-Patent Publication 1 discloses a technique in which an optical fiber is bent by contacting with a cylindrical ceramic heater as a support.

However, Patent Publication 1 does not teach a technique in which curvature radius of an optical fiber can be accurately adjusted. Furthermore, in the technique described in Patent Publication 1, a bending process for an optical fiber having high productivity is not considered at all.

In addition, since the optical fiber is contacted with the support at a high temperature in the technique in Non-Patent Publication 1, it is feared that minute cracks, etc., will be easily generated at a contacted portion, and the optical fiber will be easily broken.

Patent Publication 1 is Japanese Unexamined Patent Application Publication No. 2005-292718. Non-Patent Publication 1 is Masahito Morimoto, “Examination of Bending Loss Using R=1 mm 90° Bending Mode Fiber 2—BPM Simulation”, The Institute of Electronics, Information and Communication Engineers, August, 2008, IEICE Technical Report Vol. 108, No. 193, p115 to 119.

### SUMMARY OF THE INVENTION

The present invention was completed by considering the above problems, and objects thereof are to provide an optical transmission medium shaping method, an optical transmission medium shaping apparatus, and an optical transmission medium manufacturing method, which can accurately adjust desire curvature radius without cracking the optical transmission medium.

In the present invention, the above problems could be solved by the following technical features.

(1) An optical transmission medium shaping method for bending an optical transmission medium using a transferring means and a noncontacting heating means, includes a transferring and heating process for heating part of the optical transmission medium by the noncontacting heating means while transferring the transferring means, and a bending process for bending the optical transmission medium.
(2) The optical transmission medium shaping method described in the above feature (1), wherein the bending process bends the optical transmission medium using a rotation jig which can adjust angular velocity.
(3) The optical transmission medium shaping method described in the above feature (2), wherein the rotation jig rotates so that rotation center thereof is arranged on the vicinity of the noncontacting heating means.
(4) The optical transmission medium shaping method described in the above feature (1), wherein the bending process bends to 90° the optical transmission medium.
(5) The optical transmission medium shaping method described in the above feature (1), wherein the bending process bends the optical transmission medium by its own weight.
(6) The optical transmission medium shaping method described in the above feature (1), wherein the noncontacting heating means is an arc discharge electrode.
(7) The optical transmission medium shaping method described in the above feature (1), wherein the transferring means transfers the optical transmission medium or the noncontacting heating means at a constant rate.
(8) The optical transmission medium shaping method described in the above feature (1), wherein the optical transmission medium is an optical fiber made of glass.
(9) The optical transmission medium shaping method described in the above feature (1), wherein the optical transmission medium is an optical fiber structure composed by plural optical fibers.
(10) The optical transmission medium shaping method described in the above feature (1), wherein the optical transmission medium bends plural portions thereon in order.
(11) An optical transmission medium shaping apparatus includes a noncontacting heating means for heating part of an optical transmission medium, and a transferring means for transferring the optical transmission medium or the noncontacting heating means, wherein the noncontacting heating means and the transferring means are operated together, and part of the optical transmission medium is heated while transferring the optical transmission medium or the noncontacting heating means.
(12) The optical transmission medium shaping apparatus described in the above feature (11) further includes a rotation jig which can adjust angular velocity.
(13) The optical transmission medium shaping apparatus described in the above feature (12), wherein the rotation jig rotates so that the rotation center thereof is arranged on the vicinity of the noncontacting heating means.
(14) The optical transmission medium shaping apparatus described in the above feature (11), wherein the noncontacting heating means is an arc discharge electrode.
(15) The optical transmission medium shaping apparatus described in the above feature (11), wherein the transferring means transfers the optical transmission medium or the noncontacting heating means at a constant rate.
(16) The optical transmission medium shaping apparatus described in the above feature (11), wherein the transferring means is a two-dimensional or three-dimensional driving stage.
(17) The optical transmission medium shaping apparatus described in the above feature (11) further includes a height adjusting means for adjusting height of the optical transmission medium and the noncontacting heating means.
(18) The optical transmission medium shaping apparatus described in the above feature (11) further includes a controlling means for controlling the noncontacting heating means and the transferring means, wherein the noncontacting heating means and the transferring means are operated together by the controlling means, and part of the optical transmission medium is heated while transferring the optical transmission medium or the noncontacting heating means.
(19) An optical transmission medium production method for bending an optical transmission medium using a transferring means and a noncontacting heating means, includes a transferring and heating process for heating part of the optical transmission medium by the noncontacting heating means while transferring the transferring means, and a bending process for bending the optical transmission medium.

According to the present invention, the optical transmission medium shaping method and the optical transmission medium shaping apparatus, which can accurately adjust desire curvature radius without cracking the optical transmission medium, can be provided.

### BRIEF DESCRIPTION OF THE DRAWINGS

FIG. 1 includes schematic views showing an optical transmission medium shaping apparatus of First Embodiment, and FIG. 1A is a front view and FIG. 1B is a right side view.

FIG. 2 includes schematic views showing an optical transmission medium shaping method of the First Embodiment, and FIG. 2A is a view in which an optical fiber is carried on an optical fiber carrying mount, FIG. 2B is a view in which there is continuously carried out a transferring and heating process and a bending process, and FIG. 2C is a view which finishes the curvature of the optical transmission medium.

FIG. 3 includes schematic views showing an optical transmission medium shaping apparatus of the Second Embodiment, and FIG. 3A is a front view and FIG. 3B is a right side view.

FIG. 4 includes schematic views showing an optical transmission medium shaping method of the Second Embodiment, and FIG. 4A is a view in which an optical fiber is carried on an optical fiber carrying mount, FIG. 4B is a view in which there is continuously carried out a transferring and heating process and a bending process, and FIG. 4C is a view which finishes the curvature of the optical transmission medium.

FIG. 5 includes schematic views showing an optical transmission medium shaping apparatus of the Third Embodiment, and FIG. 5A is a front view and FIG. 5B is a right side view.

FIG. 6 includes schematic views showing an optical transmission medium shaping method of the Third Embodiment, and FIG. 5A is a view in which an optical fiber is carried on an optical fiber carrying mount, FIG. 5B is a view in which there is continuously carried out a transferring and heating process and a bending process, and FIG. 5C is a view which finishes the curvature of the optical transmission medium.

FIG. 7 includes schematic views showing the optical transmission medium shaping method of the Fourth Embodiment.

FIG. 8 is a block diagram showing one example of a control circuit.

### EXPLANATION OF REFERENCE SYMBOLS

101 . . . horizontal direction transferring means, 102 . . . optical fiber carrying mount, 103 . . . supporting column, 104 . . . pressing plate, 201 . . . optical fiber supporting mount, 301 . . . supporting housing, 302 . . . supporting column, 303 . . . basic pedestal, 304,304′ . . . rotation jig, 305 . . . lever, 306 . . . transferable pedestal, 308 . . . U-shaped bracket, 401 . . . computer, 402 . . . transferring means driving circuit, 403 . . . noncontacting heating means driving circuit, 404 . . . rotation jig driving circuit, 405 . . . lifting mechanism driving circuit, A . . . arc discharge electrode, F . . . optical fiber, G . . . groove.

### DESCRIPTION OF PREFERRED EMBODIMENTS

In the following, embodiments of the present invention will be explained in detail with reference to the figures.

### (1) First Embodiment

### Structure

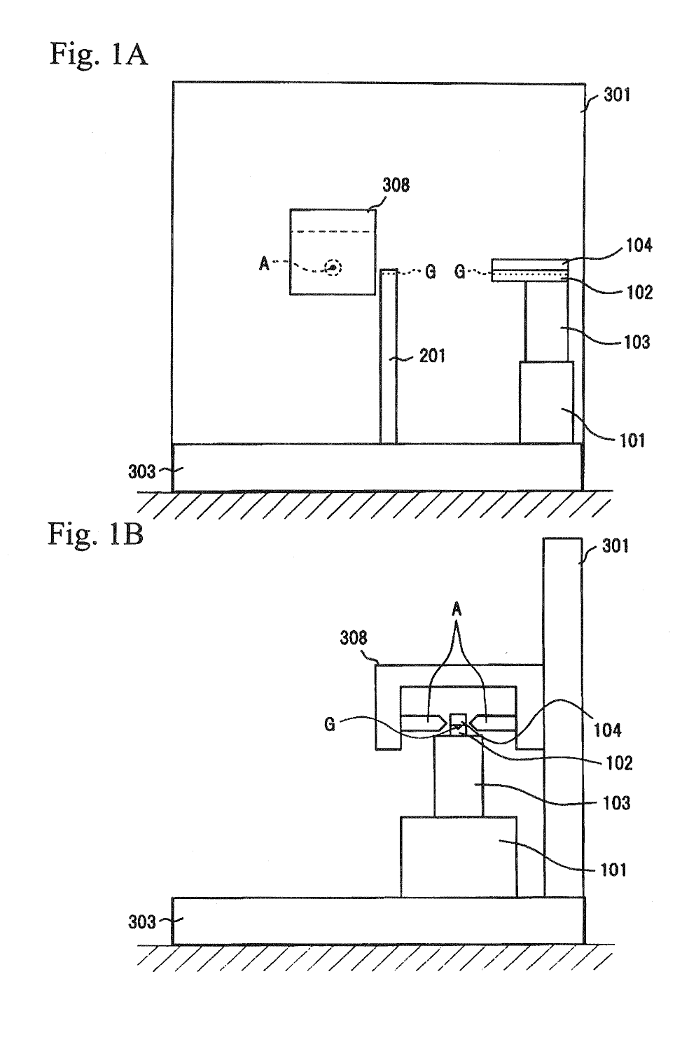

FIG. 1 includes schematic views showing an optical transmission medium shaping apparatus of the First Embodiment, and FIG. 1A is a front view and FIG. 1B is a right side view.

Reference numeral 101 indicates a horizontal transferring means which is a transferring means, reference numeral 102 indicates an optical fiber carrying mount, reference numeral 103 indicates a supporting column, reference numeral 104 indicates a pressing plate, reference numeral 201 indicates an optical fiber supporting mount, reference numeral 301 indicates a supporting housing, reference numeral 303 indicates a basic pedestal, reference numeral 308 indicates a U-shaped bracket, reference letter A indicates an arc discharge electrode which is a noncontacting heating means, and reference letter G indicates a groove.

The optical transmission medium shaping apparatus of the First Embodiment has an arc discharge electrode A for heating part of the optical fiber and a horizontal transferring means 101 for transferring the optical fiber.

Additionally the arc discharge electrode A and the horizontal transferring means 101 are operated together, and thereby, the part of the optical fiber is heated while transferring the optical fiber.

Specifically, it is preferable that a basic pedestal 303 be carried on a plane and a support housing 301 be fixed on the basic pedestal 303, as shown in FIG. 1.

Then, a U-shaped bracket 308 can be fixed in the support housing 301.

In addition, it is preferable that a horizontal transferring means 101 and an optical fiber supporting mount 201 be provided on the basic pedestal 303.

Whereby, relative position of the transferring means 101 and a noncontacting heating means A can be fixed.

The horizontal transferring means 101, an optical fiber carrying mount 102, a supporting column 103, and a pressing plate 104 are constituted as one body.

The horizontal transferring means 101 can be transferred in a crosswise direction of FIG. 1A.

Then, the optical fiber on the optical fiber carrying mount 102 can be transferred by fixing the optical fiber carrying mount 102 via the supporting columns 103 on the horizontal transferring means 101.

It is preferable that the horizontal transferring means 101 be composed of a manual or automatic ball screw mechanism, etc., and that the optical fiber be transferred in a horizontal direction at a constant rate.

Here, it is preferable that height between the optical fiber and the arc discharge electrode A can be adjusted by providing a lifting mechanism which is a height adjusting means in the supporting column 103.

That is, heating temperature to the optical transmission medium is precisely adjusted indirectly by adjusting position of the optical transmission medium to the noncontacting heating means in a vertical direction.

In addition, it is preferable that a groove G for stabilizing the position of the optical fiber be provided on the optical fiber carrying mount 102 and the optical fiber be pressed thereto by a pressing plate 104.

The groove G may be a V-shaped groove, a rectangular groove, or the like.

The optical fiber supporting mount 201 is a mount for horizontally supporting the optical fiber.

The optical fiber is suspended between the optical fiber supporting mount 201 and the optical fiber carrying mount 102.

It is preferable that the lifting mechanism, which is a height adjusting means, also be provided on the optical fiber supporting mount 201.

In addition, it is preferable that the groove G also be provided on the optical fiber supporting mount 201.

The arc discharge electrode A is provided in the U-shaped bracket 308, as shown in FIG. 1B.

Here, as a noncontacting heating means, a burner, etc., can also be used in addition to the arc discharge electrode A.

However, it is preferable that it be the arc discharge electrode A from the viewpoint of efficient shaping of the optical transmission medium at a high temperature.

According to use of the noncontacting heating means, it is not feared that the optical fiber will be damaged since the bending portion of the optical fiber does not contact with the heating means.

Operation

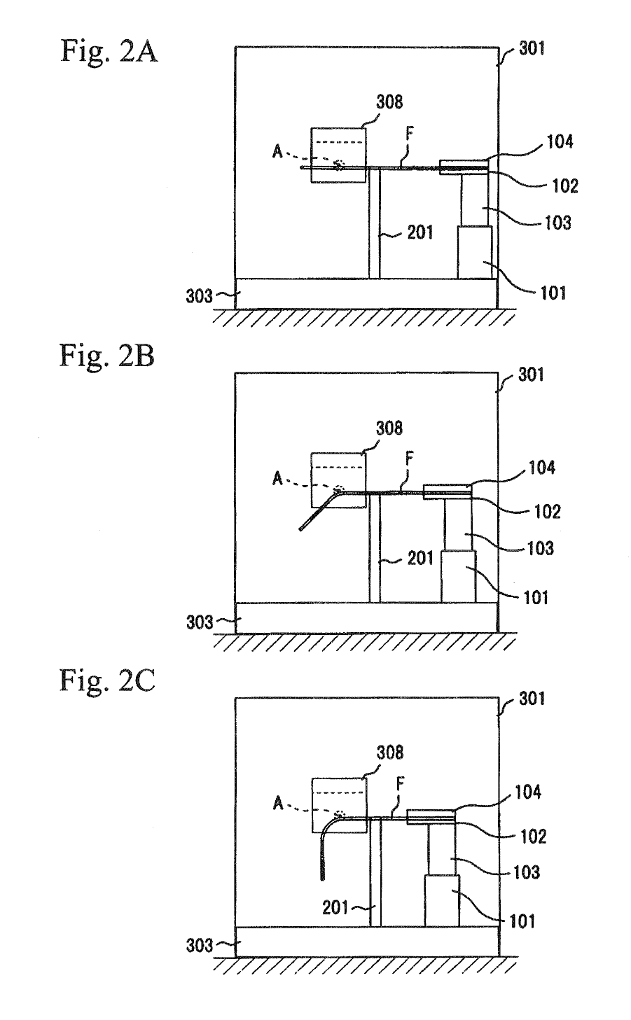

FIG. 2 includes schematic views showing an optical transmission medium shaping method of the First Embodiment, and FIG. 2A is a view in which an optical fiber is carried on an optical fiber carrying mount, FIG. 2B is a view in which there is continuously carried out a transferring and heating process and a bending process, and FIG. 2C is a view which finishes the curvature of the optical transmission medium.

Reference letter F indicates an optical fiber which is an optical transmission medium.

The optical transmission medium shaping method of First Embodiment is an optical transmission medium shaping method for bending an optical fiber using the horizontal direction transferring means 101 and the arc discharge electrode A, and includes a transferring and heating process for heating part of the optical fiber F by the arc discharge electrode A while transferring the optical fiber F by the horizontal direction transferring means 101, and a bending process for bending the optical fiber F.

First, as shown in FIG. 2A, the optical fiber F to be bent is suspended between an optical fiber carrying mount 102 and an optical fiber supporting mount 201.

Then, the optical fiber F is engaged in a groove G and is fixed by a pressing plate 104.

Next, as shown in FIG. 2B, the arc discharge is carried out at a desired portion by the arc discharge electrode A, while transferring the optical fiber in a horizontal direction by the horizontal direction transferring means 101, and part of the optical fiber F is heated (transferring and heating process).

Then, the optical fiber is heated to a temperature exceeding a softening point of the optical fiber and as a result, it is bent by its own weight (bending process).

That is, in the First Embodiment, the optical fiber F is bent at a position heated by the arc discharge electrode A, by its own weight.

Then, since the optical fiber F is continuously transferred by a horizontal transferring means 101 during the above bending, the optical fiber F is successively heated in a given range, and minute curvatures are continued so as to form a bending portion.

Here, heating temperature of the optical fiber is adjusted depending on temperature of arc discharge, and distance between the arc discharge electrode A and the optical fiber F; however, it is preferable that the temperature exceed a softening point of material which constitutes the optical fiber F.

In addition, in the case in which the optical fiber F is made of plural materials and temperature thereof is not identical, the highest temperature is adopted.

Here, the softening point is a value measured according to Japanese Industrial Standard R3103-1.

Next, as shown in FIG. 2C, when the arc discharge and the transferring of the horizontal direction transferring means 101 are stopped at a desired position, the curvature of the optical fiber F is stopped after bending to 90°.

Subsequently, natural cooling is carried out, the optical fiber F is detached from the optical transmission medium shaping apparatus, and shaping of the optical fiber F is finished.

Here, the optical fiber to be shaped may be made of any materials such as glass, plastic, etc., and the material can be suitably selected depending on the application.

However, it is preferable that the optical fiber be made of glass from the viewpoint of accurate curvature.

In addition, the optical fiber may be a single core optical fiber, or it may be an optical fiber structure composed by plural optical fibers, and number of the optical fiber processed at once is not restricted.

Here, an optical transmission medium, in which the curvatures are formed at two portions or more, can also be produced by repeating the optical transmission medium shaping method of the present invention. Specifically, an optical fiber in a meandering shape, etc., can be formed by successively bending the optical transmission medium at plural positions.

Thus, a space saving optical circuit can be produced by using the optical transmission medium in which an optical path is optionally changed.

Here, the curvature radius r of the optical fiber can be calculated as follows.

Transferred distance of the horizontal transferring means 101 is set to be X (mm).

When the curvature radius to be calculated is set to be r (mm) and angle of the curvature of the optical fiber is set to be θ(rad), length of bending portion of the optical fiber is defined as rθ(mm).

In addition, in the present invention, since the transferred distance X and the length of bending portion rθ agree, the equation X=rθ is satisfied.

When this equation is converted to change per unit time, the equation dX/dt=(rdθ)/dt . . . (1), is satisfied.

Since the dX/dt is transfer rate V (mm/s) of the horizontal transferring means 101 and the dθ/dt is angular velocity ω(rad/s) in the curvature of the optical fiber, the equation (1) is converted to the equation V=rω . . . (2).

Therefore, the curvature radius r is defined as the equation r=V/ω . . . (3).

Thus, the curvature radius r of the optical fiber is decided by the transfer rate V of the horizontal transferring means 101 and the angular velocity ω in the curvature of the optical fiber.

Therefore, for example, when the angular velocity ω is held constant, the curvature radius can be increased by increasing the transfer rate V, whereas the curvature radius can be decreased by reducing the transfer rate V.

In this way, the curvature radius r can be accurately adjusted.

### (2) Second Embodiment

### Structure

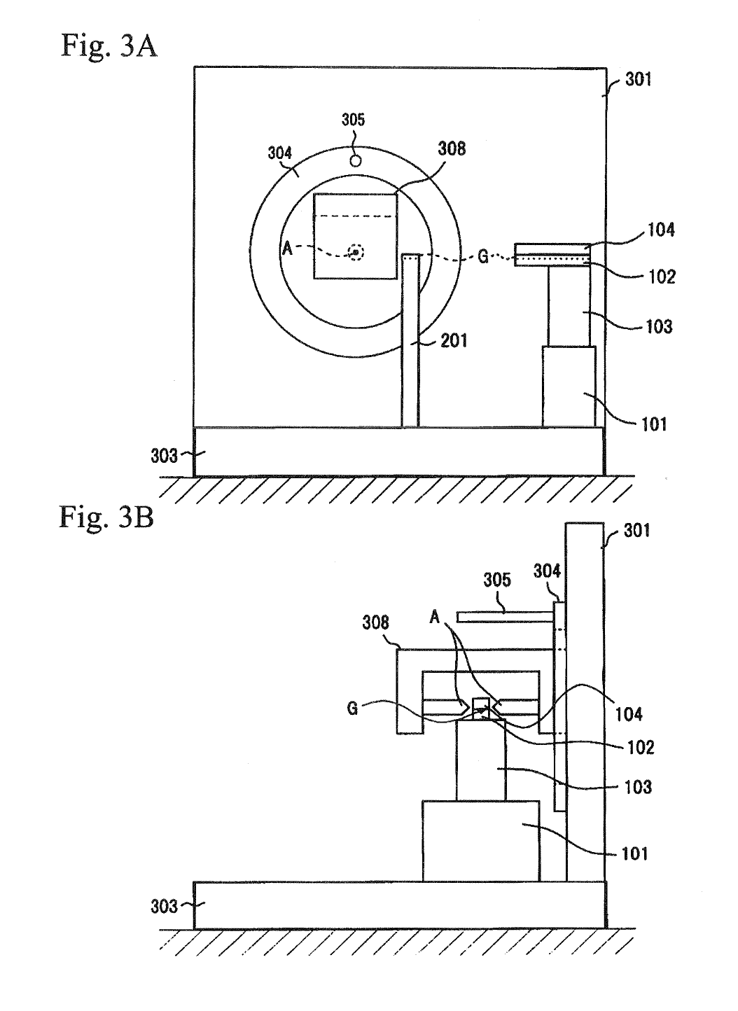

FIG. 3 includes schematic views showing an optical transmission medium shaping apparatus of the Second Embodiment, and FIG. 3A is a front view and FIG. 3B is a right side view.

Reference numeral 304 indicates a rotation jig, and reference numeral 305 indicates a lever which bends the optical transmission medium.

In the optical transmission medium shaping apparatus of the Second Embodiment, as shown in FIGS. 3A and 3B, a rotation jig 304 which adjusts angular velocity and is rotatable, is provided on a supporting housing 301 and a lever 305 which bends the optical transmission medium is provided on the rotation jig 304.

Therefore, curvature radius of the optical transmission medium can be widely adjusted by also adjusting not only transfer rate of the horizontal transferring means 101 but also the angular velocity of the rotation jig 304.

Other structures are identical to those of First Embodiment, and detailed description is omitted.

Here, in this embodiment, the rotation center of the rotation jig 304 is arranged in the vicinity of the arc discharge electrode A; however, the rotation center of the rotation jig 304 can also be arranged in the vicinity of the curvature radius of the optical fiber center.

Operation

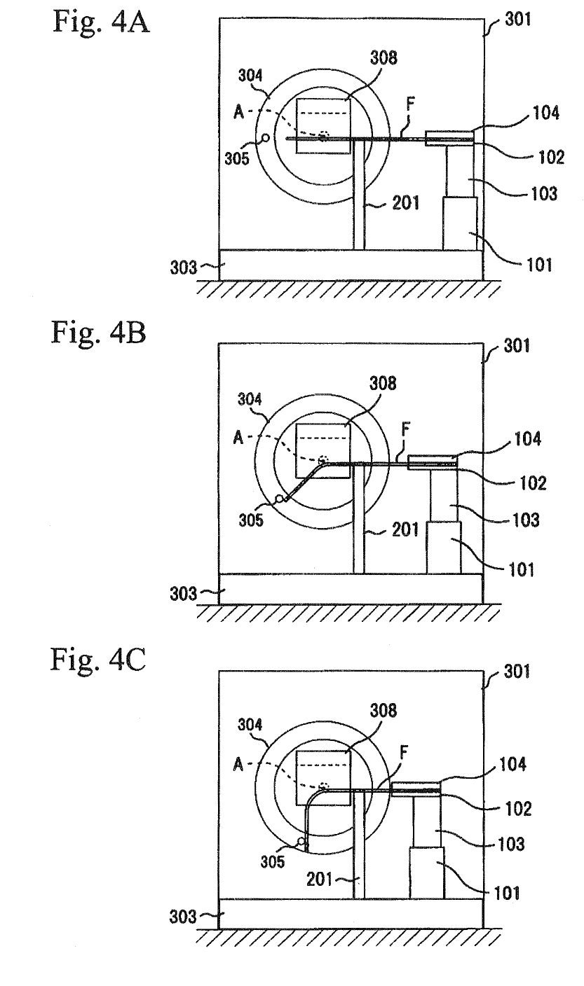

FIG. 4 includes schematic views showing an optical transmission medium shaping method of the Second Embodiment, and FIG. 4A is a view in which an optical fiber is carried on an optical fiber carrying mount, FIG. 4B is a view in which there is continuously carried out a transferring and heating process and a bending process, and FIG. 4C is a view which finishes the curvature of the optical transmission medium.

Here, other operations are identical with those of the First Embodiment, and detail description is omitted.

First, as shown in FIG. 4A, the rotation jig 304 is adjusted so that the lever 305 contacts with the upper part of the optical fiber F.

Next, as shown in FIG. 4B, the optical fiber F is pushed out after the transferring and heating processing, and the optical fiber F is bent by rotating counterclockwise in FIG. 4 the rotation jig 304, using the lever 305.

In the Second Embodiment, since the curvature is adjusted by the rotation jig 304 and the lever 305, it is preferable that a heating temperature be lower than of the First Embodiment so that the optical fiber is prevented from bending by its own weight.

Specifically, it is preferable that the temperature exceed a strain point of material which constitutes the optical fiber F and be below a softening point thereof.

It is more preferable that it exceed an annealing point thereof and be below the softening point.

Here, in the case in which the optical fiber F is made of plural materials and temperature thereof is not identical, the highest temperature is adopted.

Here, the strain point and the annealing point are values measured according to Japanese Industrial Standard R3103-2.

The heating temperature can be precisely adjusted by vertically controlling position of the optical fiber F for the arc discharge electrode A.

Additionally, as shown in FIG. 4C, transferring of the horizontal transferring means 101, arc discharging, and rotation of the rotation jig 304 are stopped at a desired position.

Here, the curvature radius can also be controlled by contacting the lever 305 from below the optical fiber F and by supporting the curvature, at the same heating temperature as that of the First Embodiment.

### (3) Third Embodiment

### Structure

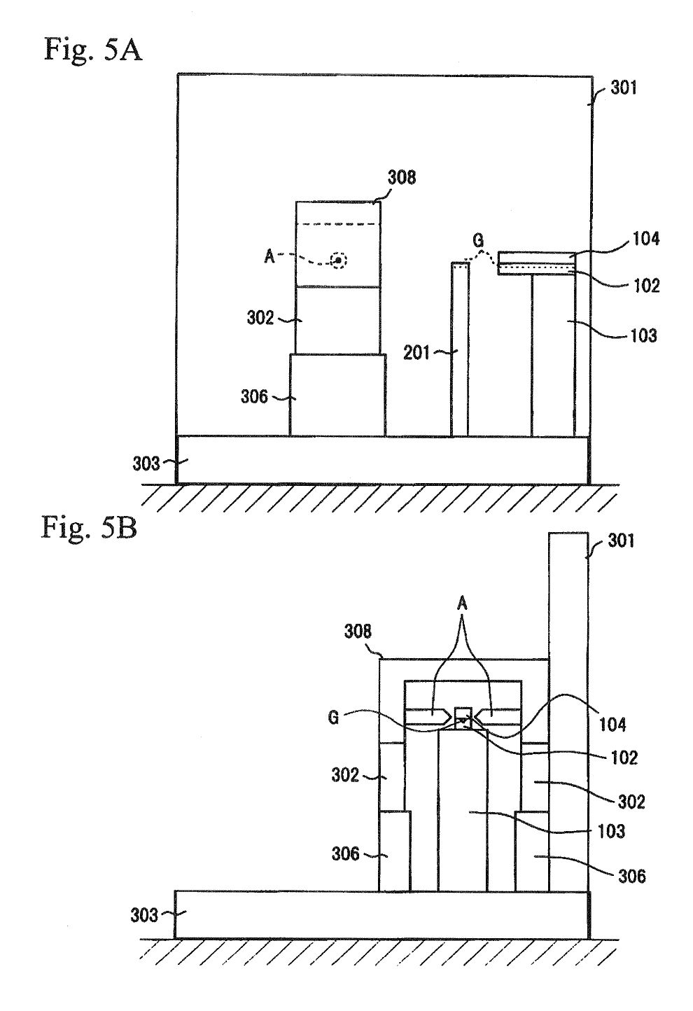

FIG. 5 includes schematic views showing an optical transmission medium shaping apparatus of Third Embodiment, and FIG. 5A is a front view and FIG. 5B is a right side view.

Reference numeral 302 indicates a supporting column and reference numeral 306 indicates a transferable pedestal which is a transferring means.

An optical transmission medium shaping apparatus of the Third Embodiment has an arc discharge electrode A for heating part of an optical fiber and a transferring pedestal 306 for transferring the arc discharge electrode A.

Then, the arc discharge electrode A and the transferring pedestal 306 are operated together, and the part of the optical fiber is heated while transferring the arc discharge electrode A.

That is, the arc discharge electrode A, which is not the optical fiber, is transferred.

Specifically, as shown in FIGS. 5A and 5B, it is preferable that two transferable pedestals 306 be provided on a basic pedestal 303.

The transferable pedestal 306, the supporting column 302 and the U-shaped bracket 308 are constituted as a one body.

The transferable pedestal 306 can be transferred in a horizontal direction of FIG. 5A.

Additionally, two supporting columns 302 are provided on the two transferable pedestals 306, respectively, and the U-shaped bracket 308 are fixed on the two supporting columns 302, and thereby the arc discharge electrode A can be transferred.

Here, in the Third Embodiment, the U-shaped bracket 308 is not fixed to the supporting housing 301.

It is preferable that the transferable pedestal 306 have a manual or automatic ball screw mechanism, etc., and that the optical fiber be transferred in a crosswise direction at a constant rate.

Here, it is preferable that height of the optical fiber and the arc discharge electrode A can be adjusted by providing a lifting mechanism, which is a height adjusting means, on the supporting column 302.

Other structures are identical with those of the First Embodiment, and detail description is omitted.

Here, as described in the Second Embodiment, the rotation jig 304 and the lever 305 may also be used.

Operation

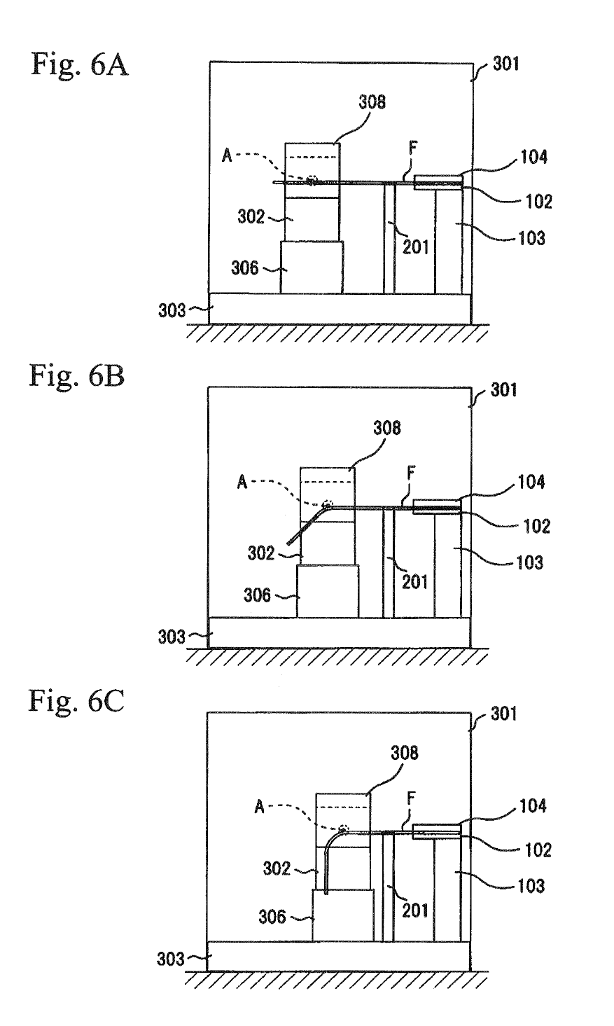

FIG. 6 includes schematic views showing an optical transmission medium shaping method of the Third Embodiment, and FIG. 6A is a view in which an optical fiber is carried on an optical fiber carrying mount, FIG. 6B is a view in which there is continuously carried out a transferring and heating process and a bending process, and FIG. 6C is a view which finishes the curvature of the optical transmission medium.

The optical transmission medium shaping method of the Third Embodiment is an optical transmission medium shaping method for bending an optical fiber using the transferable pedestal 306 and the arc discharge electrode A, and includes a transferring and heating process for heating part of the optical fiber F by the arc discharge electrode A while transferring the arc discharge electrode A by the transferable pedestal 306, and a bending process for bending the optical fiber F.

That is, the arc discharge electrode A, which is not the optical fiber F, is transferred.

Other operations are identical with those of the First Embodiment, and detail description is omitted.

First, as shown in FIG. 6A, the optical fiber F to be bent is suspended between an optical fiber carrying mount 102 and an optical fiber supporting mount 201.

Then, the optical fiber F is engaged in a groove G and is fixed by a pressing plate 104.

Next, as shown in FIG. 6B, the arc discharge is carried out at a desired portion by the arc discharge electrode A, while transferring the arc discharge electrode A in a horizontal direction by the transferable pedestal 306, and part of the optical fiber F is heated (transferring and heating process).

Then, the optical fiber is heated to a temperature exceeding a softening point of the optical fiber and as a result, it is bent by its own weight (bending process).

Next, as shown in FIG. 6C, when the arc discharge and the transferring of the transferable pedestal 306 are stopped at a desired position, the curvature of the optical fiber F is stopped after bending to 90°.

Here, as described in the Second Embodiment, the rotation jig 304 and the lever 305 may also be used.

In this case, a similar effect to that of the Second Embodiment can be obtained by rotating the rotation jig 304 while transferring at the same speed and in the same direction as those of the noncontacting heating means A.

### (4) Fourth Embodiment

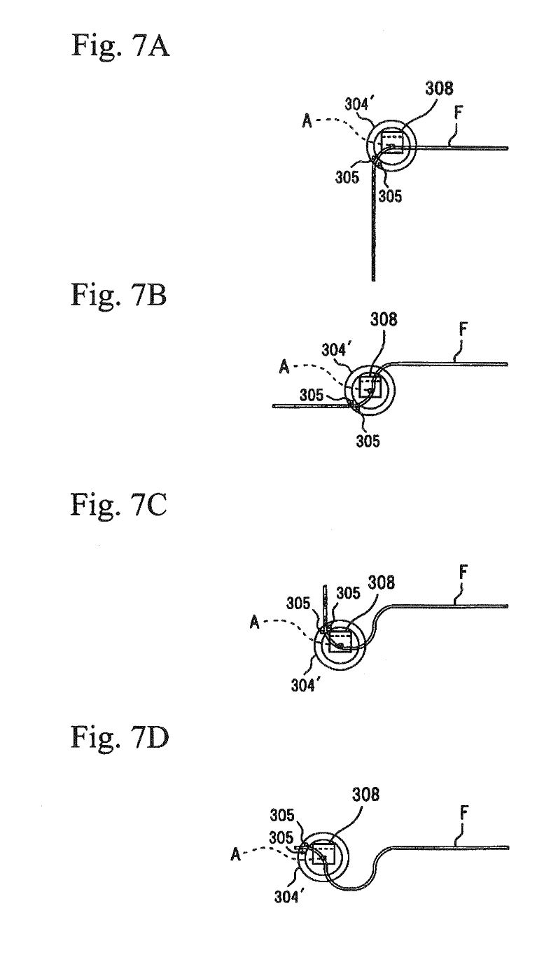

FIG. 7 includes schematic views showing the optical transmission medium shaping method of the Fourth Embodiment.

Reference numeral 304′ indicates a rotation jig with two levers 305.

Here, only a U-shaped bracket 308 and the rotation jig 304′ are shown as an optical transmission medium shaping apparatus.

The U-shaped bracket 308 and the rotation jig 304′ can be two-dimensionally or three-dimensionally moved by using a two-dimensional or three-dimensional driving stage, which is not shown, as a transferring means.

As a result, the optical fiber can be accurately and easily shaped in a desired shape by bending plural portions on the optical transmission medium in order, as described in FIGS. 7A to 7D.

Here, bent optical transmission medium can be produced by using the optical transmission medium shaping methods of each embodiment.

Control Circuit

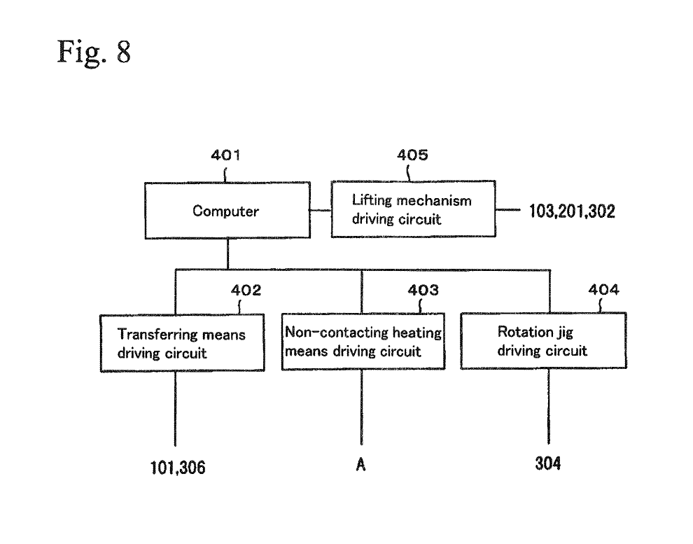

FIG. 8 is a block diagram showing one example of a control circuit.

Reference numeral 401 indicates a computer, which is a controlling means, reference numeral 402 indicates a transferring means driving circuit, reference numeral 403 indicates a noncontacting heating means driving circuit, reference numeral 404 indicates a rotation jig driving circuit, and reference numeral 405 is a lifting mechanism driving circuit.

An optical transmission medium shaping apparatus of another embodiment of the present invention has an arc discharge electrode A which heats part of an optical fiber F, transfer means 101, 306 which transfer the optical fiber F or the arc discharge electrode A, and a computer 401 which controls operation of the arc discharge electrode A and the transfer means 101, 306.

That is, the arc discharge electrode A and the transferring means 101, 306 are operated together by the computer 401, and part of optical fiber F is heated while transferring the optical fiber F or the arc discharge electrode A.

The controlling circuit shown in FIG. 8 is arranged in a suitable place such as the inside of a supporting housing 301.

The operation of the controlling circuit is unified by the computer 401.

The computer 401 has a CPU, memory, various interfaces, etc., and it is preferable that an operation program or various data which is necessary for the operation be stored in the memory.

The transferring means driving circuit 402 is a circuit for driving a motor or the like, which transfers the horizontal transferring means 101 or the slidable pedestal 306 in a crosswise direction.

The noncontacting heating means driving circuit 403 is a circuit for controlling exothermic reaction temperature, etc., by current variable to the arc discharge electrode A, etc.

The rotation jig driving circuit 404 is a circuit for driving a motor, etc., which rotates the rotation jig 304.

The lifting mechanism driving circuit 405 is a circuit for driving a motor, etc., for transferring the lifting mechanism in a vertical direction when the lifting mechanism is provided on the supporting column 103, 302, the optical fiber supporting base 201, or the like.

The transferring means driving circuit 402, the noncontacting heating means driving circuit 403, and the rotation jig driving circuit 404 are operated together by the computer 401, and therefore, the optical transmission medium F can be smoothly shaped.

### EXAMPLES

In the following, the present invention will be explained based on Examples.

### Example 1

In the Example 1, an optical transmission medium shaping apparatus of the first embodiment was used.

An L-shaped bracket made of aluminum was prepared as a basic pedestal 303.

A stepping motor driving ball screw type of automatic X-axis stage was prepared as a horizontal transferring means 101, a supporting column 103, an optical fiber carrying mount 102 and a pushing plate 104.

An arc discharge electrode unmounted in an optical fiber fusing apparatus produced by Furukawa Electric Co., Ltd., was used as an arc discharge electrode A.

A commercial U-shaped bracket made of glass epoxy was used as a U-shaped bracket 308.

An optical fiber (trade name: made by GI50 multi-mode, clad diameter: 0.125 mm, cover outer diameter: 0.25 mm, length: 200 mm, produced by Furukawa Electric Co., Ltd.) made of quartz glass was used as an optical fiber F.

Here, covering was removed from a tip to 50 mm.

The distance in a vertical direction between the optical fiber and the center of the arc discharge electrode was set to about 0.5 mm.

A starting point of the arc discharge was set in the case in which a position 10 mm from the tip of the optical fiber was most close to the arc discharge electrode.

Thus, angular velocity ω in the curvature of the optical fiber during the arc discharge was adjusted to be about π/2 (rad/s).

Under the above conditions, the automatic X-axis stage and the arc discharge electrode were operated together, and each optical fiber was bent to 90° by controlling transfer rate V of the automatic X-axis stage to 1, 2, 5 or 10 (mm/s) and by carrying out the arc discharge for 1 second, respectively.

Main conditions, calculated value of radius of curvature r, and measured value of radius of curvature r are shown in Table 1.

TABLE 1

| Transferring rate of | Angular velocity in | | |
|---|---|---|---|
| automatic X-axis | curvature | Curvature radius r (mm) | |
| stage V | of optical fiber ω | Calculated | Measured |
| (mm/s) | (rad/s) | values | values |
| 1 | π/2 | 2/π | 0.62 |
| 2 | π/2 | 4/π | 1.31 |
| 5 | π/2 | 10/π | 3.25 |
| 10 | π/2 | 20/π | 6.43 |

As described above, calculated value and measured value were nearly in agreement, and therefore, an optical fiber having a desired radius of curvature could be formed.

In addition, cracks could hardly be observed, even when a bend portion was magnified by a microscope, since the optical fiber is heated in a noncontact manner.

### Example 2

In the Example 2, an optical transmission medium shaping apparatus of the second embodiment was used.

A stepping motor driving type of automatic θ-axis rotary stage of the stepping motor drive was prepared as rotation jig 304.

A column made of aluminum having a diameter of 5 mm was prepared as a lever 305, and it was fixed to the automatic θ-axis rotary stage.

Here, the rotation jig 304 was fixed to an L-shaped bracket made of aluminum so that the rotation center thereof was the arc discharge electrode.

In addition, the distance in a vertical direction between the optical fiber and the center of the arc discharge electrode was set to about 1 mm, and therefore, the optical fiber was prevented from bending by its own weight during the arc discharge.

Under the above conditions, the automatic X-axis stage and the arc discharge electrode were operated together, and each optical fiber was bent to 90° by controlling transfer rate V of the automatic X-axis stage and the angular velocity ω of the automatic θ-axis rotary stage to values shown in Table 2 and by carrying out the arc discharge, respectively.

Main conditions, calculated value of radius of curvature r, and measured value of radius of curvature r are shown in Table 2.

Here, the other conditions were the same as those in Example 1.

TABLE 2

| Transferring rate of | | | |
|---|---|---|---|
| automatic X-axis | Angular velocity of | Curvature radius r (mm) | |
| stage V | automatic θ-axis rotating | Calculated | Measured |
| (mm/s) | stage ω (rad/s) | values | values |
| 1 | π/2 | 2/π | 0.64 |
| 1 | π/3 | 3/π | 0.94 |
| 1 | π/6 | 6/π | 1.99 |
| 2 | π/3 | 6/π | 1.85 |
| 5 | π/6 | 30/π | 9.73 |
| 10 | π/3 | 30/π | 9.31 |
| 20 | π | 20/π | 6.46 |
| 40 | 2π | 20/π | 6.12 |

As described above, calculated value and measured value were nearly in agreement, and therefore, an optical fiber having a desired radius of curvature could be formed.

In addition, cracks could hardly be observed, even when a bend portion was magnified by a microscope, since the optical fiber is heated in a noncontact manner.

Here, the radius of curvature in Example 2 could be adjusted to be wider than that in Example 1.

Additionally, in Example 2, the optical fiber could be bent faster than in Example 1, and productivity could also be increased.

### Comparative Example 1

The optical fiber having the same structure as that of the Example 1 was heated by only the arc discharge without driving the automatic X-axis stage. As a result, the optical fiber could be bent at radius of curvature of about 0.2 mm; however, it could not be shaped at another radius of curvature.

1. An optical transmission medium shaping method for bending an optical transmission medium using a transferring means and a noncontacting heating means, comprising a transferring and heating process for heating part of the optical transmission medium by the noncontacting heating means while transferring the transferring means, and a bending process for bending the optical transmission medium.

2. The optical transmission medium shaping method according to claim 1, wherein the bending process bends the optical transmission medium using a rotation jig which can adjust angular velocity.

3. The optical transmission medium shaping method according to claim 2, wherein the rotation jig rotates so that rotation center thereof is arranged on the vicinity of the noncontacting heating means.

4. The optical transmission medium shaping method according to claim 1, wherein the bending process bends to 90° the optical transmission medium.

5. The optical transmission medium shaping method according to claim 1, wherein the bending process bends the optical transmission medium by its own weight.

6. The optical transmission medium shaping method according to claim 1, wherein the noncontacting heating means is an arc discharge electrode.

7. The optical transmission medium shaping method according to claim 1, wherein the transferring means transfers the optical transmission medium or the noncontacting heating means at a constant rate.

8. The optical transmission medium shaping method according to claim 1, wherein the optical transmission medium is an optical fiber made of glass.

9. The optical transmission medium shaping method according to claim 1, wherein the optical transmission medium is an optical fiber structure composed by plural optical fibers.

10. The optical transmission medium shaping method according to claim 1, wherein the optical transmission medium bends plural portions thereon in order.

11. An optical transmission medium shaping apparatus comprising:
a noncontacting heating means for heating part of an optical transmission medium, and
a transferring means for transferring the optical transmission medium or the noncontacting heating means,
wherein the noncontacting heating means and the transferring means are operated together, and part of the optical transmission medium is heated and bent while transferring the optical transmission medium or the noncontacting heating means.

12. The optical transmission medium shaping apparatus according to claim 11 further comprising a rotation jig which can adjust angular velocity.

13. The optical transmission medium shaping apparatus according to claim 12, wherein the rotation jig rotates so that a rotation center thereof is arranged in the vicinity of the noncontacting heating means.

14. The optical transmission medium shaping apparatus according to claim 11, wherein the noncontacting heating means is an arc discharge electrode.

15. The optical transmission medium shaping apparatus according to claim 11, wherein the transferring means transfers the optical transmission medium or the noncontacting heating means at a constant rate.

16. The optical transmission medium shaping apparatus according to claim 11, wherein the transferring means is a two-dimensional or three-dimensional driving stage.

17. The optical transmission medium shaping apparatus according to claim 11 further comprising a height adjusting means for adjusting the height of the optical transmission medium and the noncontacting heating means.

18. The optical transmission medium shaping apparatus according to claim 11 further comprising a controlling means for controlling the noncontacting heating means and the transferring means, wherein the noncontacting heating means and the transferring means are operated together by the controlling means, and part of the optical transmission medium is heated while transferring the optical transmission medium or the noncontacting heating means.

19. An optical transmission medium production method for bending an optical transmission medium using a transferring means and a noncontacting heating means, comprising a transferring and heating process for heating part of the optical transmission medium by the noncontacting heating means while transferring the transferring means, and a bending process for bending the optical transmission medium.
